(19) United States
(12) Patent Application Publication
(10) Pub. No.: US 2025/0315865 A1
(43) Pub. Date: Oct. 9, 2025

(54) SYNTHETIC AUDIOVISUAL ADVERTISEMENT CREATION

(71) Applicants: Mark Levin, Jackson, WY (US); Travis Beale, Jackson, WY (US)

(72) Inventors: Mark Levin, Jackson, WY (US); Travis Beale, Jackson, WY (US)

(21) Appl. No.: 17/938,902

(22) Filed: Sep. 6, 2022

(51) Int. Cl. G06Q 30/0241

(52) U.S. Cl. CPC G06Q 30/0276; G06Q 30/0277

(57) ABSTRACT

Disclosed is the creation of a synthetic audiovisual work composed of a pre-existing audio file and an image logically related to the content of the audio file. An advantage of the synthetic audiovisual work creation is its potential to be automated and mass produce variants of the audiovisual work.

### FIELD OF THE INVENTION

The present invention relates to the field of advertisement creation and more specifically to the field of automated video synthesis.

### BACKGROUND

For as long as there has been “free” entertainment and activities, there has been advertising. Historically, mass entertainment has catered to advertisers, but as the transaction costs were lowered for the creation of entertainment content, content began to significantly outpace advertising. For almost whatever an entity desires to advertise, there is logical content waiting to be paired with it. What is now needed is the lowering of transaction costs to create and apply advertising to logical content that can be created with a minimum of effort and resources.

Therefore, there is a need for a dynamic production of audiovisual advertisements that can be created from a de minimis starting point.

### SUMMARY

Advertising exists everywhere you look from televisions, computers, mobile phones, restaurants, sporting events, retail shopping environments to outdoor billboards across the world. The present invention is taking a unique approach to creating a new advertising experience. The technology takes components from different advertising experiences, exchanges, and programmatic workflows to create synthetic audiovisual advertisements. Synthetic audiovisuals can combine elements of display advertising and video advertising with audio ads and makes this experience interactive through a QR code or clickable area on a user's mobile phone, desktop computer, or connected television. The experience is such that a consumer would be able to hear the audio advertisement and see the visual representation of that particular advertiser and be able to engage with it. Traditionally, audio ads are not visual and cannot be engaged with. This methodology and invention solves both of those challenges with the current market for audio advertising.

The invention takes metadata from the programmatic marketplace as well as the ad itself, and turns that information into dynamically represented synthetic advertisements on any device (mobile, desktop, connected tv, and digital out of home). This requires minimal interaction from the advertisers and the unique element is the technology does this automatically through the proprietary nature of pre-existing schema. Programmatic advertising is very complex with thousands of different signals and data passing through at milliseconds of time. This invention is able to take all that complex data and synthesize it into a new synthetic visual advertisement experience for consumers. This will improve satisfaction for advertisers so they can now track attribution and effectiveness of their audio campaigns and give the consumer the ability to interact with an advertiser in which they are actually interested.

Therefore, it is an aspect of the present invention to the creation of audiovisual advertisements.

It is a further aspect of the present invention to tailor multiple advertisement derivatives to determine success based on a field of advertisements.

It is a further aspect of the present invention to create advertisements based in an automated fashion.

It is a further aspect of the present invention to track advertisement success based on multiple advertisement runs.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of the process of the present invention.

FIG. 2A is a view of the process of the present invention.

FIG. 2B is a view of the process of the present invention.

FIG. 3 is a view of the audiovisual work of the present invention.

FIG. 4 is a view of the process of the present invention.

FIG. 5 is a view of a computer ecosystem of the present invention.

FIG. 6 is a view of a view of a computer ecosystem of the present invention.

### DETAILED DESCRIPTION

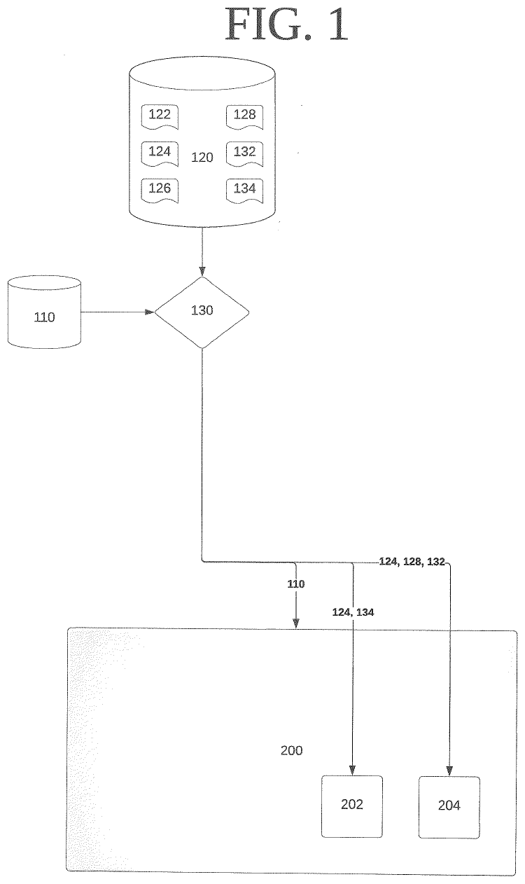

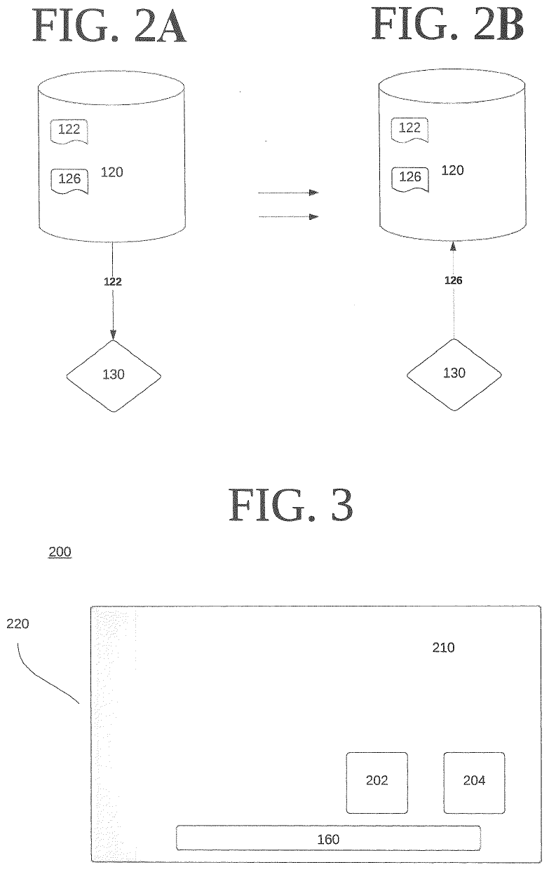

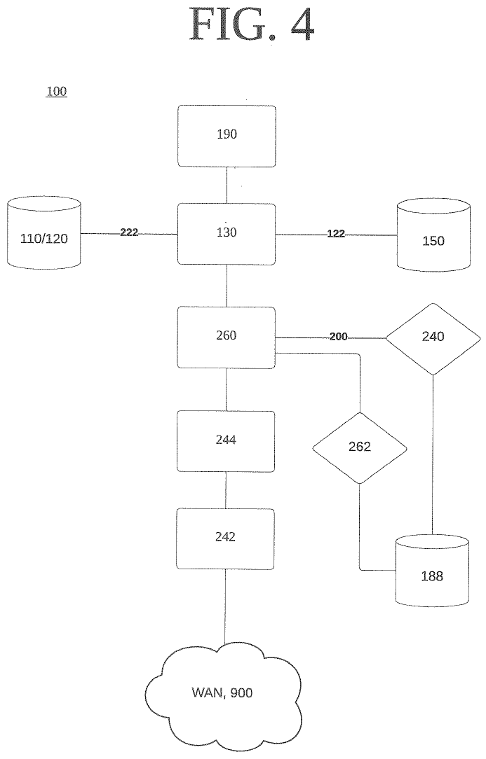

Referring first to FIG. 1, a basic embodiment of the process 100 for manufacturing a synthetic audiovisual work is shown. The process includes an automated method of creating standard video advertisements using attributes extracted and inferred from audio advertisements (“ad”). The audio ads may be delivered using the IAB VAST standard or other standard digital audio advertising format. Large social media entities tend to have digital file formats for the inclusion of advertisement via a programmatic ad exchange. The days wherein an advertisement and a forum engage in an arms-length negotiation concerning the type, number, and frequency of advertisements is fading. At the most basic level, programmatic advertising is the use of technology to buy and sell digital ads. Programmatic advertising uses an automated process, within advertiser-defined parameters, to purchase digital ad inventory across the web, mobile, apps, video, and social media. Programmatic advertising uses workflow automation and machine learning algorithms to deliver the most effective ads to audiences based on a variety of signals, like shopping patterns.

Rather than bid on advertising “blocks,” programmatic advertisement exchange is dynamic and occurs in real time. Real-Time Bidding (RTB) is a way to buy ads programmatically. With RTB, advertisers can participate in an auction when an impression becomes available. If their bid wins the auction, their ad is displayed instantly on the publisher's site. RTB is not only efficient, but it helps advertisers focus on the most relevant inventory.

In order to engage in programmatic advertising exchanges, commercial entities will aggregate information and other metadata concerning their advertisement into a discrete location or file. This discrete location or file is known in the present invention as the file precursor package 120. For purposes of the present invention, the file precursor package 120 includes certain data directly available (e.g., as a file) or points to the availability of data for purposes of later delivery (e.g., a csv file of file locations, file attributes, etc.). Either of these concepts can be applied to the file precursor package 120 of the present invention. The file precursor package 120 includes at least the audio media file 122. All other information and data can be inferred or later-acquired through the advertising synthesizer 130. However, as multiple file precursor package 120 delivery means exist, the synthesizer often need not apply its logic engine to many of the attributes and data needed to synthesize an audiovisual advertisement 200 of the present invention.

Audio ads may be accompanied by additional companion banner ads which can also be used to provide the needed metadata.

The individual metadata components present in the file precursor package 120 or can be gleaned from third party sources are as follows. The audio media file 122 is the one feature of the present invention that cannot be gleaned or logically inferred by the synthesizer 130.

The creative id 128 (crid) is a string of characters representing an identifier that is unique to the delivered ad creative within the responding advertiser's platform. The crid is a ‘one-to-many’ delivery. The tracking pixels are always unique. The ad creative not only includes the ad itself. The crid 128. The crid is agnostic to any feedback. can be delivered directly with the audio ad metadata or inferred from other metadata present in the ad, or delivered alongside the ad by a programmatic ad exchange. The global creative id 132 (gcrid) is a string of characters representing an identifier that is globally unique to the delivered ad creative. The grid can be synthesized by combining the crid and an advertising platform identifier.

Entity attributes 124 can be provided through the file precursor package 120. By entity attributes 124, it is meant any and all metadata available via the file precursor package or acquired post hoc through a logical scour, that is related to the entity or its product (and preferably the products of the audio media file 122). Usually, these entity attributes will be based on a Wide-Area Network (“WAN”), such as the Internet. Preferred forms of entity attributes 128 include a click-through url (url1) that represents the first url that the user is redirected to when clicking on the companion banner ad. This may be found as either an overall click-through url for the ad, or a click-through url specific to a companion banner ad. The entity attributes 122 landing page url (url2) represents the final url of the web page that the user is redirected to when clicking on the companion banner ad, after being taken through a chain of redirect actions. The advertiser domain (url3), also known as the adomain, is a domain that represents the advertiser who purchased the ad impression. Exemplary adomains may include the home page of the entity, brand, or product. For example, adomain for INTEL would be https://www.intel.com and for apple would be https://www.apple.com. The adomain can be delivered directly with the audio ad metadata or inferred from other metadata present in the ad, or delivered alongside the ad by a programmatic ad exchange. As another entity attribute 124, the content category (category) represents the category of the advertiser using the IABI taxonomy or other standard content taxonomy. The content category can be either delivered directly within the audio ad, or delivered alongside the ad by a programmatic ad exchange, or inferred 130 from the advertiser domain (url3). The ad image url (url4) (also known as the companion ad url) is an optional url that points to a static image of a standard size suitable for internet advertising in PNG, GIF, JPEG or other standard digital image format.

The audio media 122 url (url5) is a url that points to an audio file in MP3, WAV, OGG, or other standard digital audio format and will be fetched using a standard HTTP GET request—or the file is simply made available directly to the advertiser. The audio media file 122 should include audio media file attributes 126. By audio file attributes 126 it is meant information that is directly related to the audio file 122 itself. An example of audio file attributes 126 includes the ad period which is the duration of the audio content in the ad, expressed in seconds. The period can be delivered directly within the audio ad, or inferred 130 from the media url (u5), or delivered alongside the ad by a programmatic ad exchange. Another example of audio file attributes 126 includes the text caption url (url6) is an optional url that points to a closed-captioning file in SRT, VTT, or other standard format for closed-captioning data.

The metadata components are extracted and subsequently reassembled 130 into a synthetic video ad 200, delivered using the IAB VAST standard or other standard video advertising format. The synthesizer 130 is a primary component of the present invention that provides two significant tasks: (1) extracting from the file precursor package 120 such information and data as is available therein, and (2) scouring and inferring information and data not directly available in the file precursor package 120 and applying such data to the synthesized audiovisual work 200. Most of the information and data that are included as audio attributes 128 and entity attributes 132 can be acquired post hoc and inferentially.

The synthesizer 130 of the present invention acquires the audio file 122. At this point the present invention includes only the audio file as an advertising component. Turning now to FIGS. 2A-2B, the present invention discerns the audio file period as audio file data 126. The period as audio file attributes 126 of the audio media file is then acquired directly from meta data or inferred 130 logically through any means appropriate. One basis of inferring 130 the audio file period is simply to conduct a timed “play through” monitored by the synthesizer 130, wherein the period as audio file data 126 can be returned to the file precursor package 120 or stored arbitrarily elsewhere. For purposes of the present invention, the synthesizer 130 and its bases for synthesizing 130 through inferences and search will be used interchangeably. Once the synthesizer has acquired the period 126, it can infer 130 the type, category, and quantity of master images 220 that can be cobbled into the advertisement 200.

Image selection 222 from an image pool 110 and from the file precursor package 120 is an important basis of the present invention. Because the present invention is artificially transforming 130 a purpose-built audio advertisement into a synthetic audio-visual work, the present invention needs to acquire 130 the images 202 meant to finalize the synthesized advertisement 200. For the purposes of the present invention, the image 202 includes any type of visual work that is logically related to the audio file 122. Visual works can include static two-dimensional images, moving two-dimensional images (e.g., movies), static three-dimensional images, and moving three-dimensional images. Once the duration is known, the synthesizer 130 can acquire and cobble together one or more visual works upon an advertising slate 220. By “slate” it is meant the canvas upon which multiple visual elements are applied visually to the audio media file. In its most simplistic version, the synthesizer can acquire a single two-dimensional image that is depicted for the period of the audio media file. More intricate outputs of the present invention can result in selecting multiple two-dimensional works sequentially or simultaneously.

Returning to FIGS. 2A-2B, the present invention can not only infer 130 the duration of the audio file 122, but can also delve into the substantive content of the audio file as an audio file attribute 126. This transcript, as an audio file attribute 126, can include a time-parsed word rendering of the words of the audio file. Accordingly, the synthesizer 130 can perform a key word search and analysis utilizing conventional textual analysis routines to identify the key concepts of the advertisement. So, for, example, in an audio file having a transcript wherein the first thirty seconds discusses the problems associated with legal services, and the final thirty seconds emphasizes the important of acquiring a patent; the synthesizer can seek 222 two images: an image of an office and people within the office communicating, and then a second image depicting a U.S. Patent. The synthesizer 130 can display on the slate 220, the first master image 210 of the office interactions from time 0:00-0:30 and then 0:31-1:00 display the image of the U.S. Patent. These can be applied sequentially, or there can be an overlap in the display times, or the master images 210 can be used in combination. By “master image” it is meant the images that form the body of visual display during the rendering of the synthetic audiovisual work 200. Master images can be acquired post hoc, during dynamic synthesis of the audiovisual ad, or they can be provided with the file precursor package 120. Part of the synthesizer's analysis of multiple image files provided with the file precursor package can include a sorting and prioritization of the delivered images as entity attributes 124. Any quantity of master images can be utilized, preferably in a manner that synchronizes the images with the content of the audio file.

In addition to the use of master images 210, it is preferred that the present invention further synthesize the creation of advertisement element overlays 202, 204. The first type of advertising element overlay includes a relocation banner 202 that is overlaid upon the master image 210 to allow viewers to directly access the product or entity. The relocation banner 202 includes an ad image, preferably from the visual media package 134 delivered with the file precursor package 120. By visual media package 134, it is meant one or more images that are available for use in concert with the audio advertising. The visual media package can include master images 210, although in large part the master images will be acquired from third party sources. Other images will include advertising images principally available as supplements. An important use of these advertising images in the creation of functional image maps. An image map is an html tool which responds to the application of a selection device's cursor. An example of a selection device includes a mouse, trackpad, etc. Additional supplemental images can include functional images 204, that is to say, an image wherein the representation has a functional priority relative to a display priority, e.g. barcodes, QR codes, etc. The preferred functional image 204 includes a QR code that transports a user upon interaction therewith to a url related to the synthesized work 200. The url might include the homepage company that is the subject of the work 200, a set of critiques of the company or the product, a webpage related to the product, etc. Any url that is advantageous to be used in commercial and advertising transactions can be utilized.

Turning now to FIG. 4, part of the spirit of the present invention is that the synthesizer 130 can simply be ‘turned loose’ upon pre-existing audio files, for example, advertisements purpose-built for radio. The autonomous nature of the synthesizer can result in fabricated audiovisual works manufactured sua sponte. Furthermore, the present invention can fabricate 100 multiple alternatives of audiovisual works based on the same audio file. Accordingly, a decision-maker can be shown multiple, even hundreds or thousands, versions of autonomously created audiovisual works that the decision-maker can rank the versions that he has found. As an example embodiment, the present invention can be initialized 190 upon a predetermined set of audio files in an audio file database 150. The initialization 190 of the present invention includes the restraints and orders provided to the synthesizer 130. The initialization 190 may utilize the following attributes: audio file size, duration of audio file, audio file type, category (e.g., commercial category, such as “cars”) of audio file, quantity of synthetic files desired, cost of audio file, the intended device type (e.g. tablet, TV, smartphone), location, demographics etc. Any attribute that can be applied to an audio file and is visible as metadata for sorting and analysis can be utilized by the initializer. For explanatory purposes, the initializer 190 may target automobile advertisement audio files less than sixty seconds, and perhaps the synthesizer acquires ten such audio files 122. From the ten audio files, the initializer may create ten audiovisual works 200 of varying images types and quantities. A decision maker can view the different videos and decide which ones s/he likes best, and opine between different versions based on cost (because it is often the case that stock images will cost money, some moreso than others). One aspect of the present invention is that the present invention can autonomously run turning audio files 122 into audiovisual works 200 and then the system can send the audiovisual commercials to decision makers, also autonomously such that an owner or other possessor of an audio file can receive unsolicited or other offers and communications 240. for transformation of audio works into audiovisual works as well as the resulting products!

An owner of the audio file or other interested person/agent can be manipulate 262 or otherwise make decisions 262 based on the synthetic work. The owner can have control over all of the aspects and steps of the present invention. The owner can have a dashboard that allows it to view the product 200, its results, and the types of verticals in which the product 200 is displayed. A marketing dashboard is a visual display of the most relevant information necessary to keep track of key marketing metrics, and to achieve one or more marketing objectives. Top level marketing reports are consolidated and arranged in a single page so that the information can be monitored at a glance. Exemplary actions that can be handled by the owner include the creation of the synthetic work, such as the images that can be used therewith, the period of the ad, the landing pages to which the ad conducts users, and manage different advertisement iterations. Because the present invention allows significant automation, at the click of a button, an owner could reset the synthetic work in which new images are chosen. These potential owners or other interesting persons can be maintained in a database 188 or acquired via a scour.

The myriad of possibilities for the creation of audiovisual works has further benefits from a consumer-facing vantage point. Because of the potential for the creation of audiovisual works with relative simplicity and modest expense, a decision-maker can approve multiple versions of an advertisement. The nature of programmatic ad exchange allows multiple versions of an advertisement to run in parallel on different web platforms. Accordingly, the present invention can run, sticking with the above example, all ten versions of the automobile advertisement on a video website (e.g., YOUTUBE.com) and compare audience reactions to each ad. The present invention permits an analysis engine 242 to review results from different advertisement buys. For example, one version of the automobile commercial may feature synthesized images of an attractive woman driving a recently-purchased automobile in a mountainous setting and a second version of the automobile commercial may feature a grandfather driving his family to a beach. If the version with the grandfather is more successful, the analysis engine 242 can indicate this and the present invention through a transmitter 244 can prioritize broadcasting the grandfather commercial across web platforms. Each version can have its own individualized crid.

The transmitter 244 of the present invention is the routine by which a WAN resource makes available for broadcaster to a separate WAN resource the audiovisual works of the present invention. Transmitters 244 are known components of most programmatic ad exchange functions, it is the client side of the client-server transaction by which a WAN resource requests one or more files for display as an advertisement. The analysis engine 242 is the component of the present invention that accepts feedback from the advertising impressions on a user-by-user basis. It is an important aspect of the IAB VAST standard that much of the user experience in relation to an advertisement is anonymized. However, there are many actions that can be reported back to the advertiser. Any action that is capable of being tracked through the IAB VAST standard or other applicable standard can be utilized to inform the present invention as to the applicability of particular versions of the synthesized audiovisual work to either a decision-maker or mass consumer sentiment. The analysis engine 242 can further provide information to similar types of commercials (e.g., in a similar commercial category or other).

For example, another entity desiring to consider commercials in its commercial category, for example, automobile sales, can review the attributes of similar automobile commercials for guidance on the types of image files that may be utilized by the synthesizer for the creation of effective audiovisual files. These files can be published over the Internet or other WAN 900.

The present invention can provide ratings as data to the decision-maker concerning the attributes of consumer decisions in relation to the audiovisual works. The decision-maker can be take upon herself to manage the iterations of the work 200, including using standard advertising marketplace functions to apply iterations of the work 200 to one type of target and other iterations of the work 200 to another type of target. The decision-maker can experiment as desired based on time period, e.g. a two-week run time, wherein a new iteration replaces the prior iteration for a new two-week period.

The first time each new gcrid identifier is seen, a new audiovisual media file will be produced automatically, and the audiovisual media file can be subsequently updated with new content at a regular interval. The audiovisual media file is created 130 by downloading, converting, and combining the audio media file with a dynamically-selected slate file, or master image. First, the audio ad is analyzed for the presence of any redirects or wrappers. The chain of redirects or wrapper would be followed using standard HTTP GET requests until reaching a declaration of audio media files. Next, an audio media file can selected and subsequently fetched using a standard HTTP GET request. The master image slate file may be a video or static image, and will be automatically cut to the same duration as the audio media file, and then combined into a video media file. The slate file can be chosen using publisher-specific, advertiser-specific, or category-specific program logic. Animated or video slates, or master images, may be created using timestamped metadata such as subtitles or closed-captioning information. Master images may also contain informative or engaging content such as news headlines and images, local weather, quizzes, or polls.

A url may be selected from url1, url2, and url3 and used to generate an image of a QR code as a supplemental overlays, 202, 204. The url selection is based on fitness and character length of each of the three urls. This generated QR code 204 may point either directly to one of url1, url2, or url3, or may point to a redirection service. The url redirection service is used for both tracking purposes and so that the choice of redirection url may be handled dynamically, for example to direct the user to geographically-specific content. The QR code 204 is then overlaid on the video slate 220.

If present the ad image url4, 202, may be fetched using a standard HTTP GET request and overlaid on the video slate 220.

If present the text captions url6, may be fetched using a standard HTTP GET request, converted, and overlaid as a textual output 160 on the video slate. Alternatively text captions may be computer-generated based on analysis of the audio media file. The resulting video media file can be hosted within the Visual Audio platform, and be subsequently referenced by video ads in VAST or other standard video advertising format, and used to buy video ad impressions on mobile, TV, console, digital out-of-home (DOOH) or other devices.

The existence of text captions 160, whether originally part of the file precursor package as metadata, incorporated text captions manually etc., or construed from an engine dedicated to transform audio content into a text can be a significant source of logic for the present invention. The text captions 160, when considered as content that can be used to logically manufacture a synthetic audiovisual work, can be a significant boon and basis for any selection/choosing step of the present invention. For example, review of the text content can be used to scour and select a url, images to be used as master images or supplemental images, or locate the prospective owner of the audio file.

A url may be selected from url1, url2, and url3 and used to generate an image of a QR code as a supplemental overlays, 202, 204. The url selection is based on fitness and character length of each of the three urls. This generated QR code 204 may point either directly to one of url1, url2, or url3, or may point to a redirection service. The url redirection service is used for both tracking purposes and so that the choice of redirection url may be handled dynamically, for example to direct the user to geographically-specific content. The QR code 204 is then overlaid on the video slate 220.

If present the ad image url4, 202, may be fetched using a standard HTTP GET request and overlaid on the video slate 220.

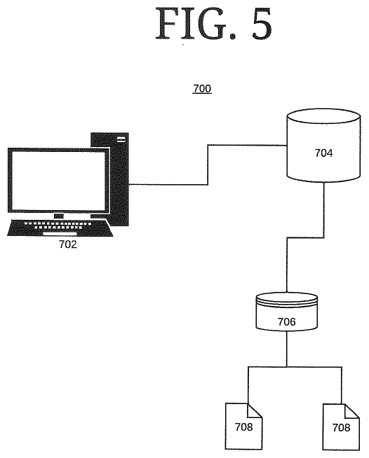

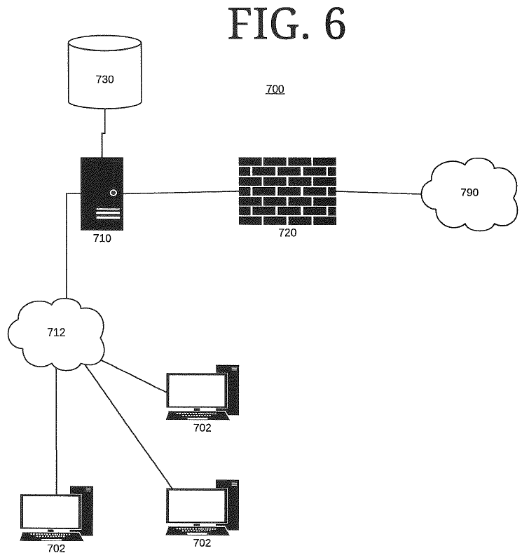

FIGS. 5-6 depict a computer ecosystem 700 of the present invention. By ecosystem it is meant one or more computers 702 that are organizationally related. The ecosystem may include computers under common ownership, computers that belong to the same network or series of networks, computers that are collaborating, etc. The present invention may be provided as a computer program product, or software that may include a computer-readable storage medium 704 having stored thereon instructions, which may be used to perform the process of the present invention across a computer ecosystem 700 according to the various embodiments disclosed herein.

A computer 702 of the present invention may include any combination of one or more computer readable media 704. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium 704 may be any tangible medium that can contain, or store a program for use by or in connection with an instruction execution system, apparatus, or device.

A computer readable signal medium 704 may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures described below illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Furthermore, the functionality of one block may be subsumed by the functionality of another block as a substep thereof. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

An ecosystem 700 may further include a computer network or data network that allows computers to exchange data. In a computer network of the present invention, networked computing devices pass data to each other along data connections. The connections between nodes are established using cable media, wireless media, or other media. The Internet or other exterior network 790 may be a component of the ecosystem 700. Nodes may include hosts such as personal computers, phones, servers, and networking hardware. Two such devices are networked together when one device is able to exchange information with the other device, whether or not they have a direct connection to each other. Computer networks of the present invention support applications such as access to the World Wide Web, shared use of application and storage servers, printers, and fax machines, and use of email and instant messaging applications. Computer networks may be included irrespective of the physical media used to transmit their signals, the communications protocols to organize network traffic, the network's size, topology, and organizational intent.

It is preferred that the network of the present invention have at least one boundary 720, and potentially multiple boundaries if a demilitarized zone is utilized. The boundary 720 may include any number of layers designed to regulate and secure the flow of information between networks. Boundary layers of the present invention may include enterprise content management software, firewalls, filters, threat management software, alarms, etc. Software for establishing a boundary may be run on a server 710 with server storage 730 of the present invention, which may include directory services controlling access credentials.

To combat security risks posed by network connections, firewalls are frequently used. A firewall may be a hardware or software component that filters network traffic so that communications with unauthorized third parties are blocked but legitimate network functions may be carried out. Frequently, the filters applied by a firewall are specified by a set of policies defining characteristics of network messages that either should pass through the firewall or that should be blocked. Because different levels of communication may be appropriate depending on the origin or destination of messages, firewall policies may be provided for each application that executes on a computing device and communicates over a network.

A firewall may have an outward side facing a global network, such as the Internet. The opposite side of the firewall may be a private network that is protected by the firewall. The private network may include any number of host machines (e.g., computers) each addressable by its own IP address. The physical construction of the network may be such that all data packets intended for one of the IP addresses behind the firewall pass through the firewall. Using the firewall rules, which may be set by a network administrator or other user, the firewall may determine whether to allow or deny certain data packets and/or determine where to route particular data packets based on the IP addresses to which the packets are directed. The determination of where to route data packets may be done using the IP addresses of the host machines in the private network.

Depending on the addressing scheme used by the network, the IP addresses of the host machines may be static or dynamic. Static IP addresses do not change over time, and thus once they are set in the firewall rules, there is no need to update them. The Internet Protocol version Four (IPv4) addressing system commonly uses static addressing, while IPV6 may use dynamic addressing. Dynamic IP addresses may change over time and thus, there is a need to update the firewall rules as changes occur. When a small Local Area Network (LAN), such as a domestic network in a private residence, is linked to a larger network such as the Internet, the link is often through a gateway router acting as a firewall. One of the functions of the firewall is to protect the LAN from intrusion from outside.

A service directory accessible by a server 710, usually on server storage 730, stores information about network resources across a domain. An example of a directory service is Active Directory. The main purpose of Active Directory is to provide central authentication and authorization services for Windows-based computers. Active Directory also allows administrators to assign policies, deploy software, and apply critical updates to an organization. Active Directory stores information and settings in a central database.

An Active Directory structure is a hierarchical framework of objects. The objects fall into three broad categories: resources (e.g. printers), services (e.g. e-mail) and users (e.g., user accounts and groups). The Active Directory provides information on the objects, organizes the objects, controls access and sets security. Certain objects can also be containers of other objects. An object is uniquely identified by its name and has a set of attributes—the characteristics and information that the object can contain—defined by a schema, which also determines the kind of objects that can be stored in the Active Directory.

Typically, the highest object in the hierarchy is the domain. The domain can be further sub-divided into containers called Organizational Units. Organizational units give a semblance of structure to the organization either based on administrative structure or geographical structure. The organizational unit is the common level at which to apply group policies, which are Active Directory objects themselves called Group Policy Objects. Policies can also be applied to individual objects or attributes as well as at the site level (i.e., one or more IP subnets).

The present invention may use one of more communication networks to foster information exchange throughout the computers of the ecosystem. Communication networks might either be private or public. In a private network, communications between multiple computers occur in a secure environment that prevents access from outside the network without appropriate authentication. These networks are considered as “trusted” networks because the communication signals securely travel from one computer to another within the private network without being exposed to the external environment.

Public networks such as the Internet, on the other hand, are not secure because the communication over these networks is not private and is susceptible to interception by other computers. In addition, the public networks cannot guarantee the delivery of the data packets being sent. They allow packets to be injected into, or ejected out of, the networks indiscriminately, and analyzed while in transit. To keep data sent over a public network private, a Virtual Private Network (VPN) is commonly established on top of a public network when two computers use the public network to communicate with each other. In a Virtual Private Network, data sent from one computer to another is encrypted by a security gateway and transmitted in encrypted form over the public network to a second security gateway connected to the receiving computer. The second gateway decrypts the data before forwarding it to the receiving computer. Such a private channel established on top of another network is referred to as a network tunnel.

In order to set up a Virtual Private Network, a user first establishes a path to a VPN server and goes through an AAA process (Authentication, Authorization and Accounting) for identification and authorization to create a secure tunnel with the server. Once the user is authorized, a secure network tunnel is established between the user and the VPN server over the public network, using a VPN protocol such as IPsec. This process requires a VPN client on the user's side, a VPN server and other VPN hardware on the other side of the tunnel, as well as appropriate user configurations.

Today's private networks often include wireless networks such as WiMAX to accommodate mobile access. In addition, to provide mobility access in a large geographic area, a private enterprise often relies on third-party wireless infrastructures besides its own wireless network. In this case, a user's device would need to be authenticated by both a third-party gateway and an enterprise authentication server before it could access the enterprise network. User credentials are typically requested by and securely returned to the third-party gateway. Once the user is authenticated and authorized, the user may communicate with the third-party wireless gateway.

The present invention includes files 708, which may include executable instructions by which the present invention runs, or files upon and with which the present invention interacts. The documents may be on local storage 704 or shared storage 730 and be created, accessed, edited, and/or otherwise modified using any of a number of applications, including for example and without limitation Final Cut Pro, Avid, Microsoft Office applications (Word, Excel, Power Point, Outlook, Visio, etc.), Adobe Reader or Acrobat, AutoCAD, SolidWorks, or any other suitable document editing application. The content of the documents may be audio tracks, video clips, images, word processing documents, presentations, spreadsheets, business documents, engineering documents, databases, etc.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A process for manufacturing a synthetic audiovisual work for an entity, said process comprising:
accepting an audio file precursor package composed of at least the following schema elements: a substantially-complete audio digital media file having an auditory period;
acquiring the following scoured elements: an ad image, a Wide Area Network (“WAN”) resource landing page, and an advertiser domain WAN resource;
generating a slate comprising a master image logically related to said advertiser domain WAN resource, adapted to be visible for said auditory period having an overlay of said ad image and a Quick Response (“QR”) code adapted to direct a user to said landing page.

2. The process of claim 1 wherein said process includes accepting a file precursor package having an auditory transcript textualizing said audio digital media file.

3. The process of claim 2 wherein said process includes acquiring multiple master images selected in reference to said auditory transcript.

4. The process of claim 2 wherein said process includes accepting a file precursor package having multiple master images.

5. The process of claim 1 further comprising compiling an auditory transcript textualizing said audio digital media file.

6. The process of claim 2 further comprising the step of acquiring multiple master images selected in reference to said auditory transcript.

7. The process of claim 1 wherein said process includes accepting a file precurser package having an entity category contextualizing a commercial sector of said entity; and acquiring multiple master images selected in reference to said entity category.

8. The process of claim 1 further comprising replacing any of said WAN resources, including said WAN resource landing page and said advertiser domain WAN resource with shortened uniform resource locater prior to said generating step.

9. The process of claim 1 wherein said generating step includes generating said slate comprising multiple master images logically related to said advertiser domain WAN resource and sequentially arrayed thereon based on a time-association with an auditory transcript textualizing said audio digital media file.

10. A synthetic audiovisual work characterizing an entity, said work comprising:
an audio file precursor package composed of at least the following schema elements: a substantially-complete audio digital media file having an auditory period;
acquired element content comprising: an ad image, a Wide Area Network (“WAN”) resource landing page, and an advertiser domain WAN resource;
an image slate simultaneously comprising during said period: (i) a master image autonomously retrieved from at least one of said audio file precursor package and an inferential engine adapted to scour a database composed of digital visual element database files based on a commercial category; (ii) and a visual representation of a WAN resource landing page, adapted from said ad image, adapted to initiate user conveyance thereto.

11. A process for creating a synthetic audio-visual work, said process comprising:
acquiring an audio file precursor package, comprising an audio digital media file, composed of advertising material having an auditory period, from a dedicated advertising work database bearing metadata concerning said advertising material;
selecting an ad image logically related to said advertising material from at least one of the following sources: (i) said file precursor package and (ii) a logical scour of a WAN based on said metadata;
choosing an advertiser url as a landing page logically related to said advertising material from at least one of the following sources: (i) said file precursor package and (ii) a logical scour of a WAN based on said metadata; and
generating a first audiovisual work product composed of a first slate comprising said ad image adapted to be visible for said auditory period having an overlay of a functional image adapted to direct a user to said landing page.

12. The process of claim 11 wherein said selecting step includes selecting a supplemental ad image logically related to said advertising material from at least one of the following sources: (i) said file precursor package and (ii) said logical scour of a WAN based on said metadata; and said generating step includes generating said first audiovisual work composed of a sequential display of said ad image and said supplemental ad image.

13. The process of claim 11 wherein said ad image includes a video file.

14. The process of claim 11 wherein said selecting step includes selecting a second ad image logically related to said advertising material from at least one of the following sources: (i) said file precursor package and (ii) a logical scour of a WAN based on said metadata; and said generating step includes generating a second audiovisual work product composed of a second slate comprising said second ad image adapted to be visible for said auditory period.

15. The process of claim 14 having an overlay of a functional image adapted to direct said user to a secondary-landing page differing from said landing page.

16. The process of claim 15 further comprising the step of communicating to a prospective owner of said audio digital file said first audiovisual work and said second audiovisual work.

17. The process of claim 11 further comprising the step of communicating to a prospective owner of said audio digital file said first audiovisual work.
